(19) United States
(12) Patent Application Publication
(10) Pub. No.: US 2023/0409920 A1
(43) Pub. Date: Dec. 21, 2023

(54) METHOD FOR PREDICTING COAXIALITY OF PARTS OF ROTARY EQUIPMENT BASED ON GA-PSO-BP NEURAL NETWORK

(71) Applicant: Harbin Institute of Technology, Harbin (CN)

(72) Inventors: Chuanzhi SUN, Harbin (CN); Qing LU, Harbin (CN); Yongmeng LIU, Harbin (CN); Jiubin TAN, Harbin (CN)

(73) Assignee: Harbin Institute of Technology, Harbin (CN)

(21) Appl. No.: 17/875,453

(22) Filed: Jul. 28, 2022

(30) Foreign Application Priority Data
Jun. 17, 2022 (CN) 202210690303.5

(51) Int. Cl. G06N 3/08

(52) U.S. Cl. CPC G06N 3/086; G06N 3/084

(57) ABSTRACT

A GA-PSO-BP neural network is provided for performing a measurement of a coaxiality error of parts of a rotary equipment and predicting a coaxiality of parts of the rotary equipment in order to solve a problem that a coaxiality error of saddle surface parts is difficult to calculate by building a traditional mathematical model based on a three-dimensional coordinate system transformation due to serious deformation of fitting surfaces of spigots. The GA-PSO-BP neural network method includes the steps of analyzing an influence source of the coaxiality error of multi-stage parts after assembly; then taking an error source as an input and the coaxiality error of the multi-stage parts after assembly as an output; and introducing a genetic algorithm to optimize an initial weight and threshold of a BP neural network, and introducing a particle swarm optimization to find optimal solutions of hyperparameters.

### CROSS REFERENCE TO THE RELATED APPLICATION

This application is based upon and claims priority to Chinese Patent Application No. 202210690303.5, filed on Jun. 17, 2022, the entire contents of which are incorporated herein by reference.

### TECHNICAL FIELD

The invention relates to a method for predicting the coaxiality of parts of rotary equipment, and belongs to the field of measurement of a coaxiality error of parts of rotary equipment.

### BACKGROUND

Parts of large high-speed rotary equipment are high-end products in the field of equipment manufacturing, and play an important role in the field of modern industry. Parts of large high-speed rotary equipment are mainly formed by stacking assembly of multi-stage parts with the assembly quality directly affecting the performance of an engine and the coaxiality as a key indicator to measure the assembly quality of the large high-speed rotary equipment. Parts can be divided into single inclined surface parts and saddle surface parts according to features of surface morphology. The single inclined surface parts have fitting surfaces in surface contact during assembly, which are less affected by pre-tightening force during bolt tightening, hardly deformed and regular in topography. A coaxiality error of multi-stage parts after assembly can be derived by building a mathematical model. The saddle surface parts have fitting surfaces in point contact during assembly, which are greatly affected by pre-tightening force during bolt tightening, and are severely deformed. Due to an interference fit, the fitting surfaces are completely covered after assembly, specific parameters cannot be measured, and thus it is difficult to solve the coaxiality error by building the mathematical model. At present, the assembly is performed according to the criteria of high and low points mainly depending on manual experience. However, such assembly is time-consuming and labor-intensive, and has high trial-and-error cost. Therefore, an intelligent method is urgently needed to predict the coaxiality error of the multi-stage saddle surface parts after assembly, so as to guide the assembly and improve the qualification rate of assembly.

### SUMMARY

In order to solve the problem that a coaxiality error of saddle surface parts is difficultly calculated by building a traditional mathematical model based on three-dimensional coordinate system transformation due to serious deformation of fitting surfaces of spigots, the present invention provides a method for predicting the coaxiality of parts of rotary equipment based on a genetic algorithm-particle swarm optimization-back propagation (GA-PSO-BP) neural network.

In order to solve the above problem, the present invention adopts the following technical solution: the present invention includes the following specific steps:
1: performing data preprocessing with a coaxiality error source as an input;
2: generating an initial population of genetic algorithm solutions, which correspond to connection weight and threshold of a BP neural network based on real number coding of individuals, and setting corresponding evolution algebra, population size, and crossover and mutation probabilities;
3: taking an error between a predicted value and an actual value of the BP neural network as a fitness function, and selecting the individuals from low to high according to the fitness function, wherein the probability of selecting the i-th individual can be expressed as:

$${P}_{i} = \frac{{l}_{i}}{{\sum }_{i = 1} {l}_{i}} , \qquad ( 1 )$$

in the formula (1), lᵢ denotes a fitness function value of the i-th individual;
4: performing crossover and mutation operations to generate a new population;
5: performing decoding by using optimal offspring individuals to obtain optimal initial weight and threshold;
6: initializing a particle swarm, comprising a swarm size, and position and speed of each particle;
7: determining solution ranges of three hyperparameters, namely, the maximum number of times of training, a learning rate, and a regularization coefficient;
8: introducing a genetic algorithm to optimize the BP neural network, and performing solving with MSE as an objective function to find an optimal hyperparameter combination;
9: introducing the optimal initial weight and threshold and the optimal hyperparameter combination into the BP neural network for training; and
10: outputting a result of a coaxiality error comprehensively predicted by the GA-PSO-BP neural network.

Further, in the step 4, the crossover operation involves randomly selecting two individuals from parents of the population, and genes on chromosomes are exchanged and recombined to generate new individuals better than the parents, where crossover of the i-th and j-th chromosomes aᵢ and aⱼ at a locus m is expressed as:

$$\{ \begin{matrix}{a}_{im} = {a}_{im} ( 1 - s ) + {a}_{jm} s \\ {a}_{jm} = {a}_{jm} ( 1 - s ) + {a}_{im} s\end{matrix} , \qquad ( 2 )$$

in the formula (2), s is a random number within [0,1]; and
a mutation formula of the n-th gene aᵢₙ of the i-th individual is as follows:

$${a}_{il} = \{ \begin{matrix}{a}_{in} + ( {a}_{in} - {a}_{max} ) \times f ( y ) & r > 0.5 \\ {a}_{in} + ( {a}_{min} - {a}_{in} ) \times f ( y ) & r \leq 0.5\end{matrix} , \qquad ( 3 )$$

$$f ( y ) = {{r}_{2} ( 1 - \frac{y}{{Y}_{max}} )}^{2} , \qquad ( 4 )$$

in the formulas (3) and (4), aₘₐₓ denotes a maximum value of aᵢₙ, aₘᵢₙ denotes a minimum value of aᵢₙ, r is a random number within [0,1], r₂ is an arbitrary number, y denotes the number of iterations, and Yₘₐₓ denotes the maximum number of evolutions.

Further, in the step 6, an iterative formula of speed and position of particle swarm optimization is as follows:

vᵢ(t+1)=ωvᵢ(t)+z₁k₁[pbestᵢ(t)−xᵢ(t)]+z₂k₂[gbestᵢ(t)−xᵢ(t)] (5)

xᵢ(t+1)=xᵢ(t)+vᵢ(t+1) (6),
in the formulas (5) and (6), ω denotes an inertia factor, z₁ and z₂ denote an acceleration constant, and an acceleration weight for pushing microparticles to pbest and gbest, z₁=z₂=2, k₁ and k₂ are respectively a random number within [0,1], vᵢ denotes the flying speed of the i-th particle, xᵢ denotes the position of the i-th particle, and t denotes time.

Further, in the step 8

$$MSE = \frac{{\sum }_{i = 1}^{f} {( T - {T}_{i} )}^{2}}{f} , \qquad ( 7 )$$

in the formula (7), T denotes an actually measured value of the coaxiality error of the multi-stage parts after assembly, Tᵢ denotes an estimated value of the coaxiality error of the multi-stage parts after assembly, and f denotes the number of samples.

The present invention has the following beneficial effects: the present invention learns an influence mechanism of the coaxiality error by analyzing an influence source of the coaxiality error of the multi-stage parts after assembly, thereby having high prediction accuracy and spending short time. The initial weight and threshold of the BP neural network are optimized by using the genetic algorithm, and optimal solutions of the hyperparameters are found by the particle swarm optimization. An R² value, a mean square error (MSE) value, and a root-mean-square error (RMSE) value of a model for comprehensively predicting the coaxiality by the GA-PSO-BP neural network are respectively 0.96, 0.0257 nm, and 0.5072 um, and the prediction accuracy is 98.3%. Thus, it can be seen that the method provided by the present invention has relatively high accuracy of predicting the coaxiality error of the parts of the large high-speed rotary equipment, solves the problem of difficulty in measuring the coaxiality error due to an unclear transfer mechanism of saddle surface parts, and can be used to guide the assembly of the multi-stage parts of the large high-speed rotary equipment.

### BRIEF DESCRIPTION OF THE DRAWINGS

FIG. 1 is a schematic assembly diagram of four-stage parts;

FIG. 2 is a topological structure of a BP neural network; and

FIG. 3 is a flow block diagram of a GA-PSO-BP algorithm.

### DETAILED DESCRIPTION OF THE EMBODIMENTS

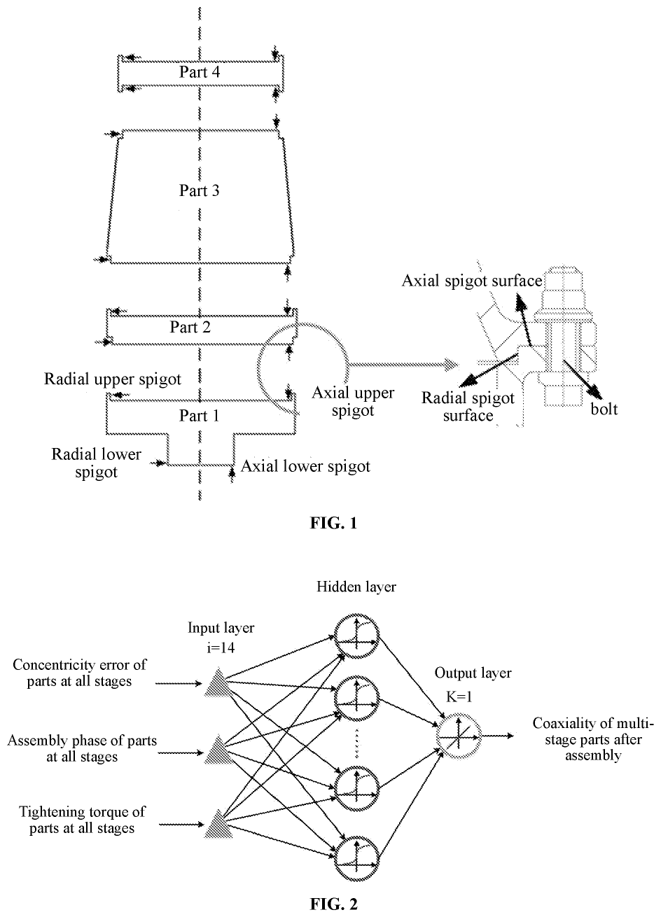

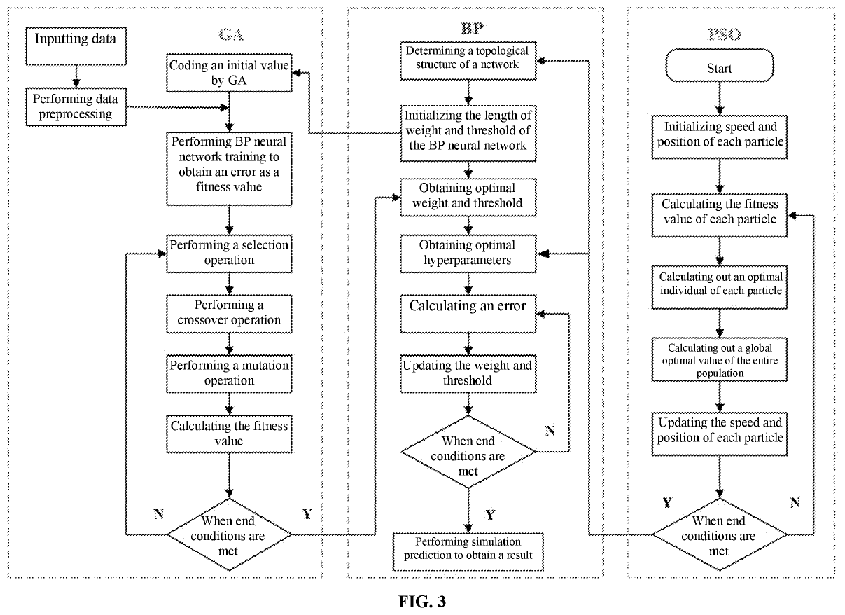

First specific embodiment: this embodiment is described with reference to FIG. 1 to FIG. 3. A method for predicting the coaxiality of parts of rotary equipment based on a GA-PSO-BP neural network described in this embodiment is implemented by the following steps:
1: data preprocessing is performed with a coaxiality error source as an input;
2: an initial population of genetic algorithm solutions, which correspond to connection weight and threshold of a BP neural network based on real number coding of individuals, is generated, and corresponding evolution algebra, population size, and crossover and mutation probabilities are set;
3: an error between a predicted value and an actual value of the BP neural network is taken as a fitness function, and the individuals are selected from low to high according to the fitness function, where the probability of selecting the i-th individual can be expressed as:

$${P}_{i} = \frac{{l}_{i}}{{\sum }_{i = 1} {l}_{i}} , \qquad ( 1 )$$

in the formula (1), lᵢ denotes a fitness function value of the i-th individual;
4: crossover and mutation operations are performed to generate a new population;
5: decoding is performed by using optimal offspring individuals to obtain optimal initial weight and threshold;
6: a particle swarm, including a swarm size, and position and speed of each particle, is initialized;
7: solution ranges of three hyperparameters, namely, the maximum number of times of training, a learning rate, and a regularization coefficient are determined;
8: a genetic algorithm is introduced to optimize the BP neural network, and solving is performed with MSE as an objective function to find an optimal hyperparameter combination;
9: the optimal initial weight and threshold and the optimal hyperparameter combination are introduced into the BP neural network for training; and
10: a result of a coaxiality error comprehensively predicted by the GA-PSO-BP neural network is output.

Second specific embodiment: this embodiment is described with reference to FIG. 1 to FIG. 3. In the step 4 of a method for predicting the coaxiality of parts of rotary equipment based on a GA-PSO-BP neural network as described in this embodiment, the crossover operation involves randomly selecting two individuals from parents of the population, and genes on chromosomes are exchanged and recombined to generate new individuals better than the parents, where crossover of the i-th and j-th chromosomes aᵢ and aⱼ at a locus m is expressed as:

$$\{ \begin{matrix}{a}_{im} = {a}_{im} ( 1 - s ) + {a}_{jm} s \\ {a}_{jm} = {a}_{jm} ( 1 - s ) + {a}_{im} s\end{matrix} , \qquad ( 2 )$$

in the formula (2), s is a random number within [0,1]; and
a mutation formula of the n-th gene aᵢₙ of the i-th individual is as follows:

$${a}_{il} = \{ \begin{matrix}{a}_{in} + ( {a}_{in} - {a}_{max} ) \times f ( y ) & r > 0.5 \\ {a}_{in} + ( {a}_{min} - {a}_{in} ) \times f ( y ) & r \leq 0.5\end{matrix} , \qquad ( 3 )$$

$$f ( y ) = {{r}_{2} ( 1 - \frac{y}{{Y}_{max}} )}^{2} , \qquad ( 4 )$$

in the formulas (3) and (4), aₘₐₓ denotes a maximum value of aᵢₙ, aₘᵢₙ denotes a minimum value of aᵢₙ, r is a random number within [0,1], r₂ is an arbitrary number, y denotes the number of iterations, and Yₘₐₓ denotes the maximum number of evolutions.

Third specific embodiment: this embodiment is described with reference to FIG. 1 to FIG. 3. In the step 6 of a method for predicting the coaxiality of parts of rotary equipment based on a GA-PSO-BP neural network as described in this embodiment, an iterative formula of speed and position of particle swarm optimization is as follows:

vᵢ(t+1)=ωvᵢ(t)+z₁k₁[pbestᵢ(t)−xᵢ(t)]+z₂k₂[gbestᵢ(t)−xᵢ(t)] (5)

xᵢ(t+1)=xᵢ(t)+vᵢ(t+1) (6),

in the formulas (5) and (6), ω denotes an inertia factor, z₁ and z₂ denote an acceleration constant, and an acceleration weight for pushing microparticles to pbest and gbest, z₁=z₂=2, k₁ and k₂ are respectively a random number within [0,1], vᵢ denotes the flying speed of the i-th particle, xᵢ denotes the position of the i-th particle, and t denotes time.

Fourth specific embodiment: this embodiment is described with reference to FIG. 1 to FIG. 3. In the step 8 of a method for predicting the coaxiality of parts of rotary equipment based on a GA-PSO-BP neural network as described in this embodiment

$$MSE = \frac{{\sum }_{i = 1}^{f} {( T - {T}_{i} )}^{2}}{f} , \qquad ( 7 )$$

in the formula (7), T denotes an actually measured value of the coaxiality error of the multi-stage parts after assembly, Tᵢ denotes an estimated value of the coaxiality error of the multi-stage parts after assembly, and f denotes the number of samples.

### EMBODIMENTS

The assembly of four-stage parts of real large high-speed rotary equipment is taken as an example. It can be analyzed from FIG. 1 that the coaxiality of the multi-stage parts after assembly not only is affected by a concentricity error of the parts at all stages due to a machining error, but relates to an assembly phase and a tightening torque during the assembly of adjacent parts. As a result, a three-layer BP neural network prediction model with 14 input nodes and 1 output node is built. 22 input nodes are respectively the concentricity and corresponding angles of four-stage parts and the assembly phase and tightening torque of adjacent parts, and 1 output node is the coaxiality of the multi-stage parts after assembly. Meanwhile, a genetic algorithm is introduced to optimize initial weight and threshold of a BP neural network, and particle swarm optimization is introduced to find optimal solutions of hyperparameters. The prediction method includes the following steps:
1: data preprocessing is performed with the concentricity and corresponding angles of parts at all stages and the assembly phase and tightening torque of the parts at all stages as an input.
2: an initial population of genetic algorithm solutions, which correspond to connection weight and threshold of a BP neural network based on real number coding of individuals, is generated, and corresponding evolution algebra, population size, and crossover and mutation probabilities are set.
3: an error between a predicted value and an actual value of the BP neural network is taken as a fitness function, and the individuals are selected from low to high according to the fitness function, where the probability of selecting the i-th individual can be expressed as:

$${P}_{i} = \frac{{l}_{i}}{{\sum }_{i = 1} {l}_{i}} \qquad ( 1 )$$

in the formula (1), lᵢ denotes a fitness function value of the i-th individual.
4: crossover and mutation operations are performed to generate a new population.

The crossover operation involves randomly selecting two individuals from parents of the population, and genes on chromosomes are exchanged and recombined to generate new individuals better than the parents, where crossover of the i-th and j-th chromosomes a; and aₜ at a locus m is expressed as:

$$\{ \begin{matrix}{a}_{im} = {a}_{im} ( 1 - s ) + {a}_{jm} s \\ {a}_{jm} = {a}_{jm} ( 1 - s ) + {a}_{im} s\end{matrix} \qquad ( 2 )$$

where s is a random number within [0,1].

A mutation formula of the n-th gene aᵢₙ of the i-th individual is as follows:

$${a}_{il} = \{ \begin{matrix}{a}_{in} + ( {a}_{in} - {a}_{max} ) \times f ( y ) & r > 0.5 \\ {a}_{in} + ( {a}_{min} - {a}_{in} ) \times f ( y ) & r \leq 0.5\end{matrix} \qquad ( 3 )$$

$$f ( y ) = {{r}_{2} ( 1 - \frac{y}{{Y}_{max}} )}^{2} \qquad ( 4 )$$

where aₘₐₓ and aₘᵢₙ denote maximum and minimum values of aᵢₙ, r is a random number within [0,1], r₂ is an arbitrary number, y is the number of iterations, and Yₘₐₓ is the maximum number of evolutions.
5: decoding is performed by using optimal offspring individuals to obtain optimal initial weight and threshold.
6: a particle swarm, including a swarm size, and position and speed of each particle, is initialized.

An iterative formula of speed and position of particle swarm optimization is as follows:

vᵢ(t+1)=ωvᵢ(t)+z₁k₁[pbestᵢ(t)−xᵢ(t)]+z₂k₂[gbestᵢ(t)−xᵢ(t)] (5)

xᵢ(t+1)=xᵢ(t)+vᵢ(t+1) (6),
where w is an inertia factor; z₁ and z₂ are an acceleration constant, and an acceleration weight for pushing microparticles to pbest and gbest, and generally z₁=z₂=2; and k₁ and k₂ are random numbers within [0,1], which are used to ensure the randomness of search.
7: solution ranges of three hyperparameters, namely, the maximum number of times of training, a learning rate, and a regularization coefficient are determined.
8: a genetic algorithm is introduced to optimize the BP neural network, and solving is performed with MSE as an objective function to find an optimal hyperparameter combination.

$$MSE = \frac{{\sum }_{i = 1}^{f} {( T - {T}_{i} )}^{2}}{f} \qquad ( 7 )$$

where T and Tᵢ respectively denote an actually measured value and an estimated value of a coaxiality error of multi-stage parts after assembly, T̅ᵢ is an average value of the actually measured coaxiality of the multi-stage parts after assembly, and f is the number of samples.
9: the optimal initial weight and threshold and the optimal hyperparameter combination are introduced into the BP neural network for training.
10: a result of the coaxiality error comprehensively predicted by the GA-PSO-BP neural network is output.

Specifically, 300 groups of acquired data samples are divided into a training set, a test set and a validation set according to a ratio of 8:1:1. There are 14 input nodes and 1 output node for the coaxiality error, and there are 8 neurons in a hidden layer, so the BP neural network has a topological structure of 14-8-1. The initial weight and threshold of the BP neural network are optimized by using the genetic algorithm, and the optimal solutions of the hyperparameters are found by the particle swarm optimization. An R² value, a mean square error (MSE) value, and a root-mean-square error (RMSE) value of a model for comprehensively predicting the coaxiality by the GA-PSO-BP neural network are respectively 0.96, 0.0257 nm, and 0.5072 um, and the prediction accuracy is 98.3%. Thus, it can be seen that the method provided by the present invention has relatively high accuracy of predicting the coaxiality error of the parts of the large high-speed rotary equipment, and can be used to guide the assembly of the multi-stage parts of the large high-speed rotary equipment.

The above are only the preferred embodiments of the present invention, and are not intended to limit the present invention in any form. Although the present invention has been disclosed as above with the preferred embodiments, it is not intended to limit the present invention. Within the scope of the technical solution of the present invention, when some changes or modifications can be made to the technical content disclosed above as equivalent embodiments of equivalent changes, any simple modification, equivalent substitution and improvement, etc. made by any person skilled in the art to the above embodiments within the spirit and principle of the present invention according to the technical essence of the present invention without departing from the content of the technical solution of the present invention still fall within the scope of protection of the technical solution of the present invention.

1. A method for predicting a coaxiality of parts of rotary equipment based on a genetic algorithm-particle swarm optimization-back propagation (GA-PSO-BP) neural network, the method for predicting the coaxiality of the parts of the rotary equipment based on the GA-PSO-BP neural network comprises:
step 1: performing data preprocessing with a coaxiality error source as an input;
step 2: generating an initial population of genetic algorithm solutions, wherein the genetic algorithm solutions correspond to a connection weight and threshold of a BP neural network based on real number coding of individuals, and setting a corresponding evolution algebra, a population size, and crossover and mutation probabilities;
step 3: taking an error between a predicted value and an actual value of the BP neural network as a fitness function, and selecting the individuals from low to high according to the fitness function, wherein a probability of selecting an i-th individual is expressed as:
$${P}_{i} = \frac{{l}_{i}}{{\sum }_{i = 1} {l}_{i}} , \qquad ( 1 )$$
wherein in the formula (1), lᵢ denotes a fitness function value of the i-th individual;
step 4: performing crossover and mutation operations to generate a new population;
step 5: performing decoding by using optimal offspring individuals to obtain an optimal initial weight and threshold;
step 6: initializing a particle swarm, comprising a swarm size, and a position and speed of each particle;
step 7: determining solution ranges of three hyperparameters, comprising a maximum number of times of training, a learning rate, and a regularization coefficient;
step 8: introducing a genetic algorithm to optimize the BP neural network, and performing solving with MSE as an objective function to find an optimal hyperparameter combination;
step 9: introducing the optimal initial weight and threshold and the optimal hyperparameter combination into the BP neural network for training; and
step 10: outputting a result of a coaxiality error comprehensively predicted by the GA-PSO-BP neural network.

2. The method for predicting the coaxiality of parts of the rotary equipment based on the GA-PSO-BP neural network according to claim 1, wherein in the step 4, the crossover operation involves randomly selecting two individuals from parents of the initial population, and genes on chromosomes are exchanged and recombined to generate new individuals better than the parents, wherein a crossover of i-th and j-th chromosomes aᵢ and aⱼ at a locus m is expressed as:
$$\{ \begin{matrix}{a}_{im} = {a}_{im} ( 1 - s ) + {a}_{jm} s \\ {a}_{jm} = {a}_{jm} ( 1 - s ) + {a}_{im} s\end{matrix} , \qquad ( 2 )$$
wherein in the formula (2), s is a random number within [0,1]; and
a mutation formula of an n-th gene aᵢₙ of the i-th individual is as follows:
$${a}_{il} = \{ \begin{matrix}{a}_{in} + ( {a}_{in} - {a}_{max} ) \times f ( y ) & r > 0.5 \\ {a}_{in} + ( {a}_{min} - {a}_{in} ) \times f ( y ) & r \leq 0.5\end{matrix} , \qquad ( 3 )$$
$$f ( y ) = {{r}_{2} ( 1 - \frac{y}{{Y}_{max}} )}^{2} , \qquad ( 4 )$$
wherein in the formulas (3) and (4), aₘₐₓ denotes a maximum value of aᵢₙ, aₘᵢₙ denotes a minimum value of aᵢₙ, r is a random number within [0,1], r₂ is an arbitrary number, y denotes a number of iterations, and Yₘₐₓ denotes a maximum number of evolutions.

3. The method for predicting the coaxiality of parts of the rotary equipment based on the GA-PSO-BP neural network according to claim 1, wherein in the step 6, an iterative formula of the speed and position of the particle swarm optimization is as follows:
vᵢ(t+1)=ωvᵢ(t)+z₁k₁[pbestᵢ(t)−xᵢ(t)]+z₂k₂[gbestᵢ(t)−xᵢ(t)] (5)
xᵢ(t+1)=xᵢ(t)+vᵢ(t+1) (6),
wherein in the formulas (5) and (6), ω denotes an inertia factor, z₁ and z₂ denote an acceleration constant, and an acceleration weight for pushing microparticles to pbest and gbest, z₁=z₂=2, k₁ and k₂ are respectively a random number within [0,1], vᵢ denotes a flying speed of an i-th particle, xᵢ denotes the position of the i-th particle, and t denotes time.

4. The method for predicting the coaxiality of parts of the rotary equipment based on the GA-PSO-BP neural network according to claim 1, wherein in the step 8
$$MSE = \frac{{\sum }_{i = 1}^{f} {( T - {T}_{i} )}^{2}}{f} , \qquad ( 7 )$$
wherein in the formula (7), T denotes an actually measured value of a coaxiality error of multi-stage parts after assembly, Tᵢ denotes an estimated value of the coaxiality error of the multi-stage parts after assembly, and f denotes a number of samples.
